(19) United States
(12) Patent Application Publication
(10) Pub. No.: US 2025/0321916 A1
(43) Pub. Date: Oct. 16, 2025

(54) Multiple PCIe Interfaces with Deadlock Avoidance

(71) Applicant: Altera Corporation, San Jose, CA (US)

(72) Inventors: Vaibhav Khamkar, San Jose, CA (US); Wei Chui Ng, Bayan Lepas (MY)

(21) Appl. No.: 19/251,075

(22) Filed: Jun. 26, 2025

(51) Int. Cl. G06F 13/42

(52) U.S. Cl. CPC G06F 13/4221; G06F 2213/0026

(57) ABSTRACT

Systems, methods, and circuitry for supporting high speed data transfers across link partners that are coupled by a communication link, such as a Peripheral Component Interconnect Express (PCIe). More specifically, integrated circuits, such as field programmable gate arrays (FPGAs), in a receiver may include multiple streams that are coupled to an application main band to improve the throughput of buffering and providing received packets to an application. The multiple streams may be first in, first out (FIFO) buffers that include a credit check to limit the risk of packet overflow. In some embodiments, integrated circuits in a transmitter may include multiple streams that are coupled to transmission processing circuitry. The transmitter may include a dynamic credit allocation system that adjusts credit allocations among the streams based on credit consumption data and congestion metrics.

### BACKGROUND

The present disclosure relates generally to integrated circuits, such as processors and/or field-programmable gate arrays (FPGAs). More particularly, the disclosure relates to systems and methods to support high speed data transfers across devices that are coupled by a communication link, such as a Peripheral Component Interconnect Express (PCIe) link.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionalities. Many integrated circuits, such as field programmable gate arrays (FPGAs), include programmable logic circuitry that may be configured with a hardware system design to implement hardware designs that may perform a wide variety of different functions. In addition to programmable logic circuitry, many integrated circuits also include hardened circuits to perform special-purpose operations, such as buffering and processing data (e.g., packets).

Indeed, an integrated circuit may be designed or, in the case of an FPGA, may be configured, to transmit and receive data. That is, an integrated circuit may be included in a receiver and/or a transmitter to facilitate the flow of packets between devices. In the context of a receiver, for example, the integrated circuit may receive packets via a communication link, such as a PCIe link. The integrated circuit may then buffer the packets that it receives from the communication link and provide the packets to an application main band (e.g., logic or circuitry). However, as communication standards advance, and packets are transmitted at a higher speed (e.g., because PCIe standards specify a higher bandwidth), the integrated circuit may experience challenges, such as packet overflow and routing congestion. Resultingly, some techniques for handling data transmission (e.g., PCIe data transmission) may suffer from deficiencies that impact the throughput of the integrated circuit as it buffers and provides the packets to the application main band. Further, in some cases, the receiver may receive different types of packets (e.g., posted, non-posted, completion) from the communication link. Some integrated circuit implementations may, therefore, be susceptible to packet overflow, leading to potential data loss and system instability. For an integrated circuit within a transmitter, in some cases, the different types of packets may be paused in a buffer of the integrated circuit (e.g., based on an ability a receiver's ability to accept packets from the transmitter). For example, a packet may be paused due to standards-based ordering rules (e.g., PCIe ordering rules) and/or congestion at the receiver. Some transmitters may utilize static routing techniques, which may be an additional cause of routing congestion.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of an example integrated circuit device of FIG. 1, in accordance with an embodiment of the present disclosure;

FIG. 3 is a block diagram of a communicative system between link partners that may include the integrated circuits of FIG. 2, in accordance with an embodiment of the present disclosure;

FIG. 4 is a block diagram of the integrated circuit of the receiver of FIG. 3, including multiple streams for packet buffering, in accordance with an embodiment of the present disclosure;

FIG. 5 is a flowchart of a method for the receiver of FIG. 4 to process packets and provide them to an application main band, in accordance with an embodiment of the present disclosure;

FIG. 6 is a block diagram of another embodiment of the integrated circuit of the receiver of FIG. 3, including credit checks and auxiliary buffers for the multiple streams to reduce the risk of packet overflow and deadlock, in accordance with an embodiment of the present disclosure;

FIG. 7 is a flowchart of a method for the receiver of FIG. 6 to process packets and provide them to an application main band, in accordance with an embodiment of the present disclosure;

FIG. 8 is a block diagram of the communicative system of FIG. 3 that includes a transmitter configured to engage in dynamic credit allocation, in accordance with an embodiment of the present disclosure;

FIG. 9 is a block diagram of the dynamic credit allocation system of the transmitter of FIG. 8, in accordance with an embodiment of the present disclosure;

FIG. 10 is a flowchart of a method for the transmitter of FIG. 9 to use the dynamic credit allocation system to improve throughput to a receiver, in accordance with an embodiment of the present disclosure; and

FIG. 11 is a block diagram of a data processing system that may incorporate the systems and methods of this disclosure, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

This disclosure relates to an integrated circuit that is designed for or configurable to support high speed data transfers across devices that are coupled by a communication link, such as a Peripheral Component Interconnect Express (PCIe) link. As mentioned above, integrated circuits may be included in devices (e.g., link partners) that may be coupled via the communication. For example, a transmitter (e.g., a first device) may be coupled to a receiver (e.g., a second device) by the communication link. The integrated circuits that are included in the transmitter and the receiver may be interfaces (e.g., PCIe interfaces) that may be used to facilitate the flow of packets between the transmitter and the receiver over the communication link. The communication link may be a single channel that is used to transport packets from the transmitter to the receiver. In some cases, the transmitter may send different types of packets to the receiver. For example, according to certain communication standards (e.g., PCIe standards), the transmitter may send posted, non-posted, and completion packets to the receiver.

Posted packets are packets that may be transmitted to the receiver without specifying that an acknowledgment be returned. Non-posted packets are packets that demand an acknowledgment from the receiver. Completion packets are transmitted by the transmitter in response to receiving an acknowledgment by the receiver (e.g., the receiver sends an acknowledgment of a non-posted packet, and the transmitter sends a completion packet in response).

As mentioned above, the receiver may receive packets from the transmitter, buffer the packets, and provide the packets to an application main band. The application main band may be any logic or circuitry (e.g., direct memory access (DMA), storage devices, memory) that may receive the packets that are provided by the transmitter. The application main band may include buffers based on its ability to accept a number of packets at a given time. In some cases, the application main band may use a credit system to inform the receiver of the type (e.g., posted, non-posted, completion) and quantity of packets it can receive. In response to information received from the credit system, and based on communication ordering rules (e.g., PCIe ordering rules) and standards, the receiver would historically provide packets to a single stream (e.g., a first in, first out (FIFO) buffer) coupled to the application main band. The stream may then provide the packets to the application main band.

However, a single stream approach may provide insufficient throughput in light of advancing communication standards. For example, certain communication standards (e.g., PCIe Gen6×16) call for an increasing amount of bandwidth (e.g., 128 gigabytes) at the receiver. To match this bandwidth specification, the integrated circuit in the receiver may include a single large stream (e.g., 2,048 bits) that is running at a set frequency (e.g., 500 megahertz). Resource and performance constraints (e.g., area within the integrated circuit, timing specifications for PCIe communications) may make it challenging to incorporate a single stream with these specifications into an integrated circuit.

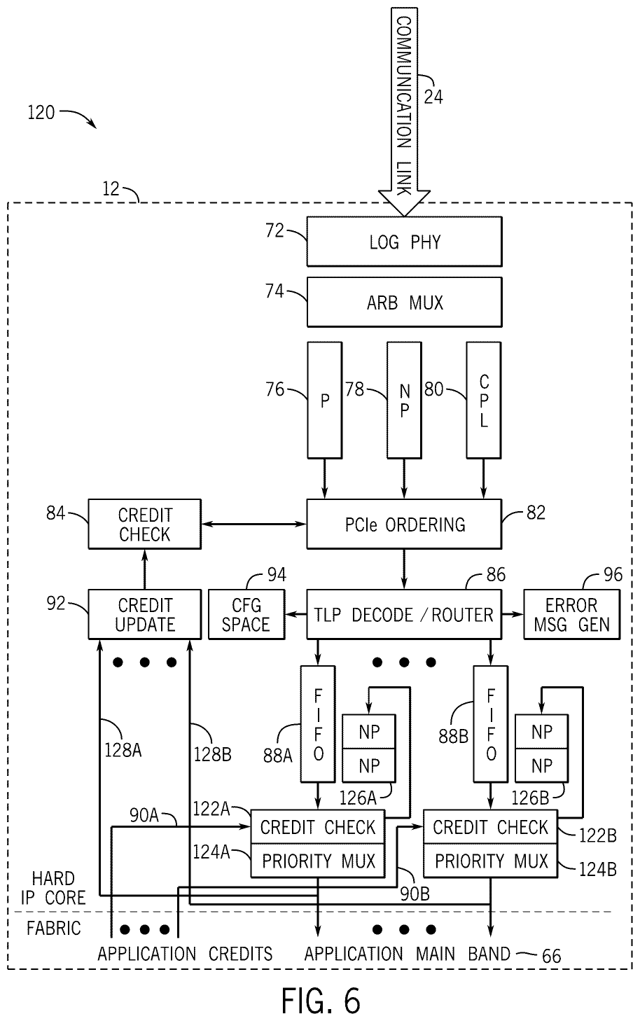

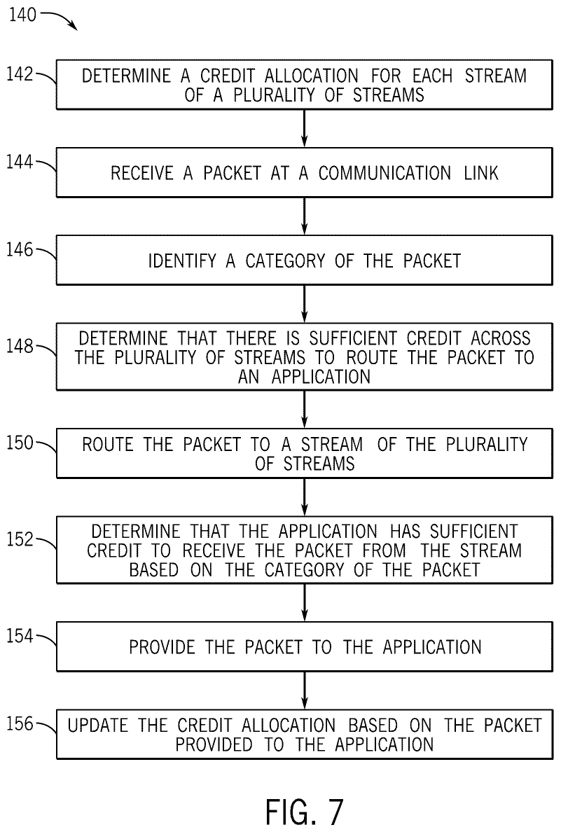

The present disclosure addresses the concerns raised by increasing bandwidth in data communications (e.g., PCIe communications). Indeed, according to aspects of the present disclosure, the integrated circuit in the receiver may include multiple (e.g., two, four, eight, and so on) independent streams that may be used to increase a throughput of packets provided to the application main band. Including multiple independent streams in the hard IP core of the integrated circuit may provide an increase in the amount of packets that the receiver can provide to the application main band. In some aspects, each stream of the integrated circuit may include a credit check. As described in more detail with reference to FIGS. 6 and 7, including a credit check on each of the multiple independent streams may reduce the likelihood of congestion and packet overflow at the application main band.

Additionally, the present disclosure also provides improvements to the data communications (e.g., PCIe communications) by addressing the transmitter side of the communications. In some aspects, the integrated circuit of the transmitter may also include multiple independent streams that may transmit packets to the receiver. The transmitter may receive a credit allocation from the receiver and transmit packets based on the credit allocation. Because the transmitter may include multiple independent streams, it may be desirable for the transmitter to dynamically allocate the credits that it receives from the receiver among the streams. That is, each stream of the transmitter may have a predetermined amount of credit for each type of packet that it may transmit. By way of example, a first stream and a second stream may both have initial credit allocations of two posted packets, two non-posted packets, and two completion packets. However, over time, the first stream may provide a higher number of posted packets to the receiver than the second stream. By reviewing credit consumption data for both streams, the transmitter can determine patterns (e.g., congestion metrics) regarding the type and number of packets that each stream provides to the receiver. The transmitter may then dynamically adjust the credit allocation for each stream to improve throughput and reduce the likelihood of congestion in its respective streams.

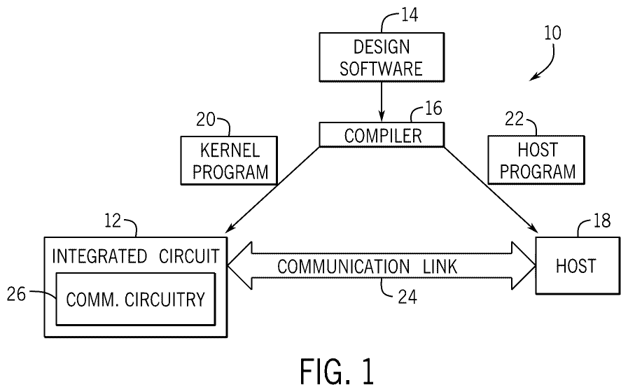

With the foregoing in mind, FIG. 1 is a block diagram of a system 10 that may include an integrated circuit for transmitting and/or receiving packets. A designer may desire to implement functionality, such as the multiple stream-based buffering of this disclosure, on an integrated circuit device 12 (such as an FPGA or an application-specific integrated circuit (ASIC)). In some cases, the designer may specify a high-level program to be implemented, such as an OpenCL program, which may enable the designer to more efficiently and easily provide programming instructions to configure a set of programmable logic cells for the integrated circuit device 12 without specific knowledge of low-level hardware description languages (e.g., Verilog or VHDL). For example, because OpenCL is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

Designers may implement their high-level designs using design software 14. The design software 14 may use a compiler 16 to convert the high-level program into a lower-level description. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, PCIe communications or direct memory access (DMA) communications. That is, in some embodiments, the host 18 may be viewed as a transmitter and the integrated circuit 12 may be viewed as a receiver. In some embodiments, the kernel programs 20 and the host 18 may enable configuration of communication circuitry 26 on the integrated circuit device 12. The communication circuitry 26 may include circuitry that is utilized to perform several different operations. For example, as discussed below, the communication circuitry 26 may include multiple buffers that are respectively utilized to provide packets to an application main band. Accordingly, the communication circuitry 26 may include circuitry to implement, for example, operations to provide packets to an application main band in accordance with a credit system and communication ordering rules (e.g., PCIe ordering rules).

While the discussion above describes the application of a high-level program, in some embodiments, the designer may use the design software 14 to generate and/or to specify a low-level program, such as the low-level hardware description languages described above. Further, in some embodiments, the system 10 may be implemented without a separate host program 22. Furthermore, in other embodiments, the communication circuitry 26 may be partially implemented in portions of the integrated circuitry device 12 that are programmable by the end user (e.g., soft logic) and in parts of the integrated circuit device 12 that are not programmable by the end user (e.g., hard logic). For example, the multiple independent buffers may be implemented in hard logic, while other circuitry included in the communication circuitry 26, including the circuitry utilized by the application main band to provide credit updates, may be implemented in soft logic. Thus, embodiments described herein are intended to be illustrative and not limiting.

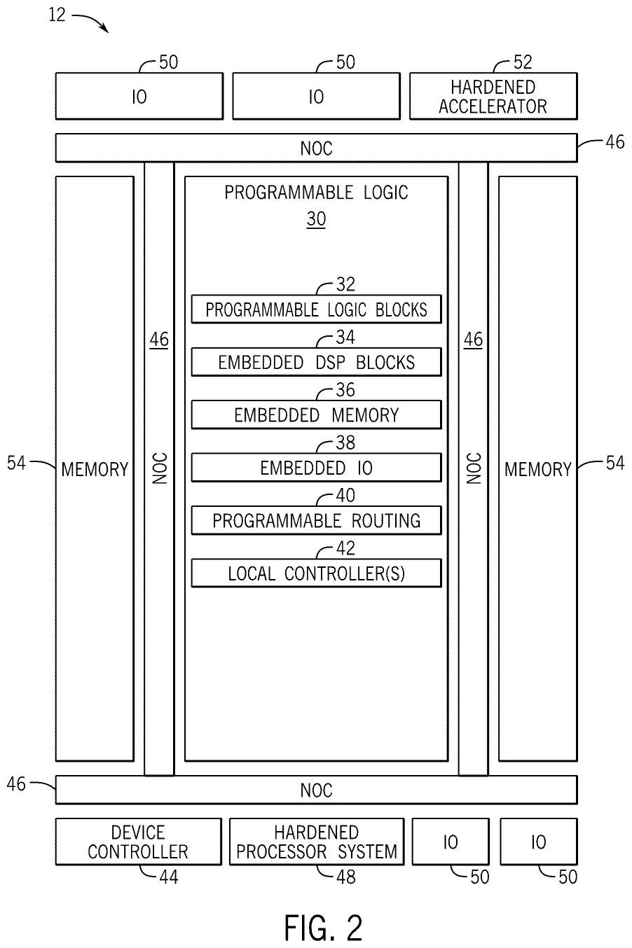

Turning now to a more detailed discussion of the integrated circuit device 12, In one example shown in FIG. 2, the integrated circuit device 12 may include programmable logic circuitry 30, which may include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any of the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded input-output (IO) blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic circuitry 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally, or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic circuitry 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

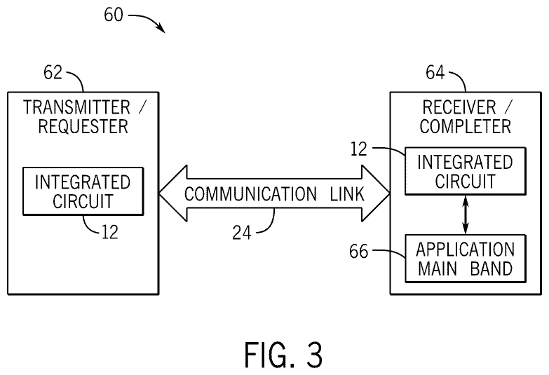

With this in mind, FIG. 3 is a block diagram of a communicative system 60 between link partners that may include integrated circuits. For example, a transmitter 62 may be communicatively coupled to a receiver 64. In this way, the transmitter 62 and the receiver 64 may be link partners that are coupled by a communication link 24. The communication link 24 may be a single channel link (e.g., single-channel PCIe link) that facilitates the exchange of data (e.g., packets) between the transmitter 62 and the receiver 64. The transmitter 62 and the receiver 64 may include one or more integrated circuits 12. For example, the integrated circuit 12 in the transmitter 62 may be a PCIe interface that may be used to direct and transmit packets to the receiver 64. Likewise, the receiver 64 may include an integrated circuit that may be a PCIe interface, which is communicatively coupled to an application main band 66. The application main band 66 may be any logic or circuitry operating that is communicatively coupled to the receiver 64. For example, the application main band 66 may be direct memory access (DMA) circuitry, storage devices or circuitry, memory, or the like. In this way, the integrated circuit 12 of the receiver 64 may buffer packets that are received by the transmitter 62 and provide the packets to the application main band 66. In some embodiments, the application main band 66 may be included in the integrated circuit 12 of the receiver 64. For example, the application main band 66 may be included in the programmable logic (e.g., the programmable logic circuitry 30 of the integrated circuit of FIG. 2) of the integrated circuit 12 of the receiver 64.

In some embodiments, the transmitter 62 and the receiver 64 may be separate components that are communicatively coupled (e.g., via the communication link 24) in a single device or system. By way of example, the receiver 64 may be a motherboard of a device, and the transmitter 62 may be an expansion card, such as memory, DMA, a solid state drive (SSD), a hard drive, a graphics card, or the like, included in the same device. Likewise, in other cases, the receiver 64 may be an expansion card in a device, and the transmitter 62 may be a motherboard in the same device. The communication link 24 may, therefore, enable bi-directional communication between the transmitter 62 and the receiver 64.

In the communicative system 60 of FIG. 3, the transmitter 62 has been labeled as the transmitter/requester. The transmitter 62 may transmit posted, non-posted, and completion packets to the receiver 64. As noted above, the non-posted packets may include a request for an acknowledgment from the receiver 64. Thus, the transmitter 62 may be referred to as a transmitter, a requester, or a combination of both. The receiver 64 is also labeled as the receiver/completer. In response to receiving a non-posted packet, the receiver 64 may send an acknowledgement to the transmitter 62. Thus, the receiver 64 may be referred to as a receiver, a completer, or a combination of both. In this way, the transmitter 62 and the receiver 64 may communicate according to a framework specified by a communication protocol (e.g., a PCIe protocol).

### Receiver Circuitry

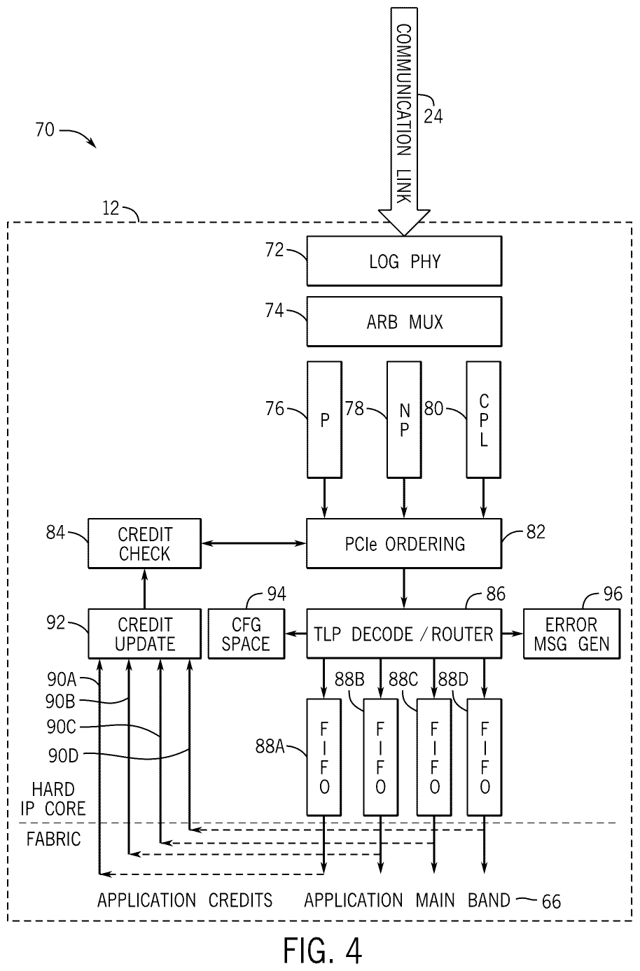

Turning now to a more detailed look at the receiver circuitry, FIG. 4 is a is a block diagram 70 of the integrated circuit 12 of the receiver 64 of FIG. 3, including multiple streams for packet buffering. As mentioned above, the integrated circuit 12 of the receiver 64 may be viewed as a collection of components that make up a communication interface (e.g., a PCIe interface) for receiving and buffering packets. The receiver 64 may be coupled to a transmitter (e.g., the transmitter 62 of FIG. 3) via the communication link 24. The communication link 24 may be a single channel link (e.g., a single-channel PCIe link). The communication link 24 may be coupled to a logical physical layer 72 of the integrated circuit 12. The logical physical layer 72 may be an interface to receive high speed data from the communication link 24. The logical physical layer 72 may be coupled to arbitration and multiplexing logic 74. The arbitration and multiplexing logic 74 may receive the data (e.g., packets) from the logical physical layer 72 and separate it into virtual interfaces (e.g., buffers). For example, the arbitration and multiplexing logic 74 may separate the packets into virtual interfaces associated with the type of packets being received. Thus, the integrated circuit may include a first virtual interface 76 for posted packets, a second virtual interface 78 for non-posted packets, and a third virtual interface 80 for completion packets.

The virtual interfaces may be coupled to ordering circuitry 82 (e.g., PCIe ordering circuitry). The ordering circuitry 82 may advance the packets towards the application main band 66 according to a communication protocol (e.g., a PCIe protocol) and a credit check 84. For example, certain communication protocols may define the order in which packets are transmitted from the three virtual interfaces 76, 78, 80 towards the application main band 66. As mentioned above, the application main band 66 may have a limited amount of bandwidth for the number of packets that it can receive and process. This limit may be referred to as credit. By way of example, the application main band may be able to accept one posted packet, but no non-posted packets, or completion packets at a given time. Alternatively, the application main band may have sufficient credit to accept two non-posted packets, but no posted or completion packets at another time. Accordingly, the application main band 66 may use credits to provide the ordering circuitry 82 with information regarding the type and number of packets it can accept. Thus, the ordering circuitry 82 may be coupled to a credit check 84. After receiving the credit information from the credit check 84, the ordering circuitry 82 may apply communication protocols (e.g., PCIe ordering rules) to determine which packets to send towards the application main band 66. By way of example, if a non-posted packet arrives at the ordering circuitry 82 first, a posted packet arrives second, and a completion packet arrives third (e.g., based on packet timestamps), but the application main band 66 only has sufficient credit for the posted packet and the completion packet, then the posted packet and the completion packet will be effectively reordered such that they are sent towards the application main band 66 before the non-posted packet.

Based on the credit check 84 and the communication protocols (e.g., PCIe ordering rules), the ordering circuitry 82 may send certain packets to a Transaction Layer Packet (TLP) decoder and router 86. The TLP decoder and router 86 may extract information from the packets and determine a stream to route the packets towards. As mentioned above, the integrated circuit 12 may include multiple streams. For example, the integrated circuit may include a first stream 88A, a second stream 88B, a third stream 88C, and a fourth stream 88D (collectively referred to as the streams 88). Each of the streams 88 may be independent from one another. For example, each of the streams 88 may be a FIFO buffer independently coupled to the application main band 66. The TLP decoder and router 86 may route the packets towards one of these streams 88. As mentioned above, the inclusion of multiple independent streams 88 may increase the throughput of the integrated circuit without causing a significant detrimental impact on hardware (e.g., area within the integrated circuit 12) and timing resources of the integrated circuit 12.

As the packets are received by the streams 88, they may be provided to the application main band 66. In response to a packet leaving a stream 88 and being provided to the application main band 66, the application may release a credit. Each stream 88 may be associated with credits. The first stream 88A may be associated with credits 90A, the second stream 88B may be associated with credits 90B, the third stream 88C may be associated with credits 90C and the fourth stream 88D may be associated with credits 90D. For example, if a non-posted packet is released from the first stream 88A, a credit 90A may be returned to a credit update 92. The credit update 92 may sum the credits 90A, 90B, 90C, 90D. The credit update 92 may also be coupled to the credit check 84. Thus, the credit update 92 may provide the sum of the credits 90A, 90B, 90C, 90D to the credit check 84. As mentioned above, the ordering circuitry 82 may use the credit check 84 to determine the type and number of packets that it can send to the TLP decode and router 86 towards the streams 88 and the application main band 66.

As will be appreciated, the integrated circuit 12 may contain additional components that may assist in buffering and routing packets from the communication link 24 to the application main band 66. For example, the integrated circuit 12 may include a configuration space component 94 and an error message generator 96. The configuration space component 94 may contain registers that may provide the TLP decode/router 86 with information (e.g., identifications and configurations) regarding the configuration and control of the link partners (e.g., the transmitter 62 and the receiver 64 of FIG. 3). Likewise, the error message generator 96 may be used to generate notifications of errors in response to communication issues, such as congestion in the streams 88, packet drops, or the like.

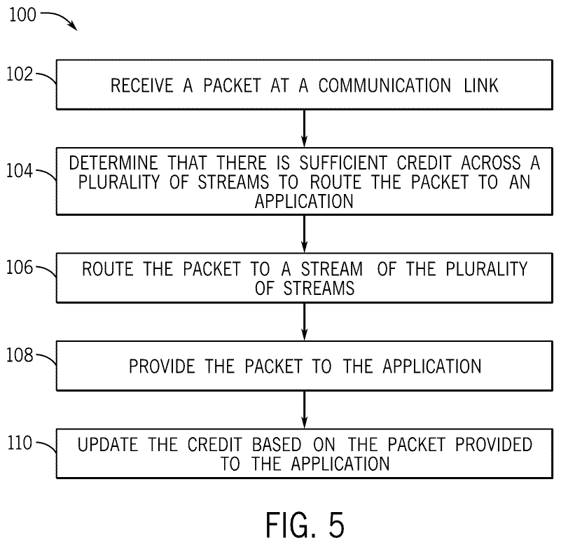

Turning now to a method by which the integrated circuit 12 of FIG. 4 may operate, FIG. 5 is a flowchart of a method 100 for the receiver to process packets and provide them to an application main band (e.g., the application main band 66 of FIG. 4). Although the following description of the method 100 is described as being performed by the integrated circuit 12 of FIG. 4, it should be noted that any suitable device capable of receiving and processing data may perform the method 100 described herein. In addition, although the method 100 is described in a particular order, it should be understood that the method 100 may be performed in any suitable order and may exclude one or more of the blocks described herein.

At block 102, the integrated circuit may receive a packet at a communication link. For example, in embodiments where the integrated circuit may be or include a PCIe interface, the integrated circuit may receive a packet from a PCIe link. The communication link may be a single channel that may carry various types or categories of packets (e.g., posted, non-posted, completion). The integrated circuit may receive the packets at, for example, a logical physical layer (e.g., the logical physical layer 72 (Log PHY) of FIG. 4) and timestamp the packets based on the time that they arrive at the integrated circuit.

At block 104, the integrated circuit may determine that there is sufficient credit across multiple streams to route the packet to an application. Indeed, an application main band may have limitations on the number of packets that it may receive at any one time. The integrated circuit may aggregate the credit that is available across all of the streams that may be coupled to the application main band and determine whether to forward the packet to one of the multiple streams based on the credit that is available and communication protocols (e.g., PCIe ordering rules).

At block 106, the integrated circuit may route the packet to a stream of the multiple streams. That is, a TLP decoder and router (e.g., the TLP decoder and router 86 of FIG. 4) may extract routing information from the packet and transmit it to a particular stream. Turning to block 108, the integrated circuit may provide the packet to the application. At this block, the packet may be included in one of the streams and may be provided to the application main band as the packet approaches the end of the stream (e.g., the front of the queue). The application main band may then provide the packet to designated logic or circuitry.

At block 110, the integrated circuit may update the credit based on the packet provided to the application. For example, the application may release a credit in response to receiving the packet. The credit may be aggregated with the credit available to the other streams on the integrated circuit (e.g., by the credit update 92 of FIG. 4). The credit may then be provided to a credit check, such that the integrated circuits can determine how and when to forward additional packets that are received and/or stored in their virtual interfaces (e.g., the virtual interfaces 76, 78, 80 of FIG. 4). In this manner, the integrated circuit may facilitate communications (e.g., PCIe communications) with a link partner (e.g., a transmitter/requester) at an increased throughput compared to prior art techniques. This may provide a technical advantage in high speed data transfers.

In some embodiments, the integrated circuit may include additional components to further improve packet buffering. For example, FIG. 6 is a block diagram 120 of another embodiment of the integrated circuit 12 of the receiver 64 of FIG. 3 that includes additional credit checks and auxiliary buffers for each of the streams to reduce the risk of packet overflow and deadlock. In the integrated circuits described with reference to FIGS. 4 and 5, the ordering circuitry 82 may be unaware of the multiple streams 88. That is, the ordering circuitry 82 may proceed as if there is a single large stream coupled to the application main band 66 (e.g., as provided in prior art systems). Thus, the credits may be aggregated by the credit update 92 (e.g., to reduce any need to reconfigure the credit check 84 and ordering circuitry 82). However, in some situations, including multiple streams 88 may lead to overflow on any one of the streams 88. Assume, for purposes of example, that a first stream 88A releases and provides a posted packet to the application main band 66. The application may release a credit that may be provided to the credit update 92. However, the credit update tracks the sum of credits across all of the available streams (e.g., stream 88A, stream 88B, stream 88C, and stream 88D). Thus, the ordering circuitry 82 may receive the credit from the credit check 84 and release a posted packet targeted at stream 88B. As mentioned above, the streams 88 are independent. Thus, stream 88B may have insufficient credit for a posted packet. This may lead to packet overflow on stream 88B and cause instability.

The integrated circuit 12 that is depicted in FIG. 6 addresses the concerns associated with packet overflow that may arise from including multiple streams 88 in the integrated circuit. Initially, it should be noted that the integrated circuit 12 depicted in FIG. 6 may include many similar components to the integrated circuit 12 depicted in FIG. 4 that may function in a similar manner. However, certain differences will be discussed below. For example, the integrated circuit 12 of FIG. 6 includes the stream 88A and 88B. Although only two streams 88 are depicted, any number of streams may be included. In this embodiment, each stream 88 is coupled to a respective credit check 122A, 122B and a priority multiplexer 124A, 124B. For example, the stream 88A may be coupled to the credit check 122A and the priority multiplexer 124A. Likewise, the stream 88B may be coupled to the credit check 122B, and the priority multiplexer 124B.

The credit checks 122A, 122B may receive the credit 90A, 90B for both streams 88A, 88B from the application main band 66. In particular, the credit 90A may be provided to the credit check 122A that is associated with the stream 88A. Similarly, the credit 90B may be provided to the credit check 122B that is associated with the stream 88B. The credit checks 122A, 122B may be used to determine whether the application main band 66 can accept a credit from the respective streams 88. As described above, the streams 88 may be FIFO buffers. Each stream 88 may be initialized to buffer a pre-allocated number of posted, non-posted, and completion packets. Thus, the initial allocation of credits may be the same across all of the streams 88. However, as packets are provided from the ordering circuitry 82 to the streams 88, and from the streams 88 to the application main band 66, the amount of credit available for the different packets may vary across the streams 88. Thus, there may be situations where the application main band 66 may be able to accept a posted packet from the first stream 88A but not the second stream 88B. In that case, the credit checks 122A, 122B provide a benefit as they reduce the risk of packet overflow.

The combination of the credit checks 122A, 122B, the priority multiplexers 124A, 124B, and auxiliary buffers 126A, 126B may provide a further benefit associated with deadlock avoidance. If the credit check 122A, 122B indicates that the application main band 66 cannot accept a non-posted packet from the top of one of the streams 88 (e.g., the front of the queue), the non-posted packets may be provided to the auxiliary buffers 124A, 124B. The auxiliary buffers 126A, 126B may receive and hold the top of the stream packet (e.g., the non-posted packet) to prevent additional packets in the stream 88 from being blocked behind the non-posted packets. Thus, in some embodiments, the credit checks 122A, 122B and the priority multiplexers 124A, 124B may be coupled to one or more auxiliary buffers 126A, 126B. The priority multiplexers 124A, 124B may forward the non-posted packets from the auxiliary buffers 126A, 126B to the application main band 66 when the application main band 66 has sufficient non-posted credit for one of the streams 88. For example, when a credit for a non-posted packet stored in the auxiliary buffer 126A becomes available for the stream 88A, the priority multiplexer 124A may retrieve a non-posted packet from the auxiliary buffer 126A and route the non-posted packet to the application main band 66. In some embodiments, when an auxiliary buffer (e.g., auxiliary buffer 126A) holds a threshold number of non-posted packets or is full, the ordering circuitry 82 may temporarily pause transmission of non-posted packets to the other streams (e.g., the stream 88B).

Taking the stream 88A as an example, assume that the head of the stream packet is a non-posted packet. The stream 88A may also hold a completion packet that is directly behind the non-posted packet. If the credit check 122A indicates that the application main band 66 cannot accept a non-posted packet from the stream 88A, then the non-posted packet may be sent to the auxiliary buffer 126A. Thus, the completion packet may be at the head of the stream 88A and, therefore, be transmitted to the application main band 66. In this manner, each of the streams 88 may be able to avoid packet overflow and deadlock, which may improve throughput to the application main band 66. When the credit check 122A receives sufficient credit for the non-posted packet, the priority multiplexer 124A may retrieve the non-posted packet from the auxiliary buffer 126A and provide the non-posted packet to the application main band 66.

As the packets are transmitted to the application main band 66, the streams 88 may provide respective credits 128A, 128B back to the credit update 92. As described above, the credit update 92 may aggregate the available credits across all of the streams 88 and provide that information to the credit check 84, which may be communicatively coupled to the ordering circuitry 82. Resultingly, the ordering circuitry 82 and the credit check 84 may be unaware of the number of streams 88 coupled to the application main band 66. A technical benefit of the disclosed embodiments may be that the circuitry of the ordering circuitry 82 and/or the credit check 84 does not need to be changed or reconfigured (e.g., compared to prior art PCIe interfaces in integrated circuits) to enable the increased throughput that is provided by the disclosed integrated circuit 12.

With this in mind, FIG. 7 is a flowchart of a method 140 for the receiver of FIG. 6 to process packets and provide them to an application main band. Although the following description of the method 140 is described as being performed by the integrated circuit 12 of FIG. 6, it should be noted that any suitable device capable of receiving and processing data may perform the method 140 described herein. In addition, although the method 140 is described in a particular order, it should be understood that the method 140 may be performed in any suitable order and may exclude one or more of the blocks described herein.

At block 142, the integrated circuit may determine a credit allocation for multiple streams (e.g., the streams 88 of FIG. 6). That is, the integrated circuit may first determine a type and an amount of packets that an application can accept (e.g., from the application main band 66 of FIG. 6) across all of the streams in the aggregate (e.g., according to the credit update 92 of FIG. 6). In the first instance, each of the streams may have a similar credit. For example, each stream may have credits for three posted packets, three non-posted packets, and three completion packets. However, it should be noted that the credit allocation for each of the streams may change over time as they buffer and provide packets of different categories to the application.

At block 144, the integrated circuit may receive a packet at a communication link, such as a communication link (e.g., a PCIe link). Further, at block 146, the integrated circuit may determine a category (e.g., posted, non-posted, completion) of the packet. For example, arbitration and multiplexing logic (e.g., the arbitration and multiplexing logic 74 of FIG. 6) may be used to separate the packets into a number of virtual interfaces (e.g., the virtual interfaces 76, 78, 80 of FIG. 6). The virtual interfaces may be coupled to ordering circuitry (e.g., the ordering circuitry 82 of FIG. 6).

At block 148, the integrated circuit may determine that there is a sufficient credit across the multiple streams to route the packet to an application. For example, the ordering circuitry may be coupled to the virtual interfaces and to a credit check (e.g., the credit check 84 of FIG. 6). The ordering circuitry may evaluate the aggregate amount of credit from the credit check to determine that the type of packet that was received at the communication link and stored in the virtual buffers may be forwarded downstream towards a TLP decoder and router (e.g., the TLP decoder and router 86 of FIG. 6) and one of the multiple streams.

At block 150, the integrated circuit may route the packet to a stream of the multiple streams. The TLP decoder and router may receive the packet from the ordering circuitry and extract information from the packet. For example, the packet may be targeted at a particular stream of the multiple streams. The TLP decoder and router may, therefore, provide the packet to the particular stream.

At block 152, the integrated circuit may determine that the application has sufficient credit to receive the packet from the stream based on the category of the packet. That is, the stream that the packet is in may have an additional credit check (e.g., the credit checks 122A, 122B of FIG. 6). As mentioned above, the additional credit check may provide a benefit as the ordering circuitry may be unaware of the credit that is provided to each stream by the application. Because each stream may have an additional credit check, the stream holding the packet may confirm that the application (e.g., the application main band) can accept the particular category of the packet at the front of its queue. If the additional credit check confirms that the application has sufficient credit for the category of the packet, at block 154, the stream may provide the packet to the application.

Conversely, if the packet is a non-posted packet, and the application does not have sufficient credit to receive the packet from the stream, then the packet may be stored in an auxiliary buffer (e.g., the auxiliary buffers 126A, 126B of FIG. 6). The stream may include components, such as a priority multiplexer (e.g., the priority multiplexers 124A, 124B of FIG. 6) to forward the packet from the auxiliary buffer to the application as more non-posted credits become available to the stream. Thus, when the application has sufficient credits to accept the non-posted packets that are stored in the auxiliary buffer, the packet may be provided to the application.

At block 156, the integrated circuit may update the credit allocation based on the packet provided to the application. That is, the integrated circuit may update the credit on the particular stream that provided the packet to the application. Additionally, the application and/or the particular stream may provide the credit to the credit update (e.g., the credit update 92 of FIG. 6), which may aggregate the credits available across the streams and provide the aggregate credit to the credit check. In this manner, each of the streams may prevent packet overflow and congestion by checking the credit for each category of packets before providing the packets to the application. Further, the integrated circuit may improve throughput without having to reconfigure existing circuitry (e.g., the credit check 84, the ordering circuitry 82 of FIG. 6) that may have been included in prior implementations of interfaces (e.g., PCIe interfaces) and integrated circuits.

### Transmitter Circuitry

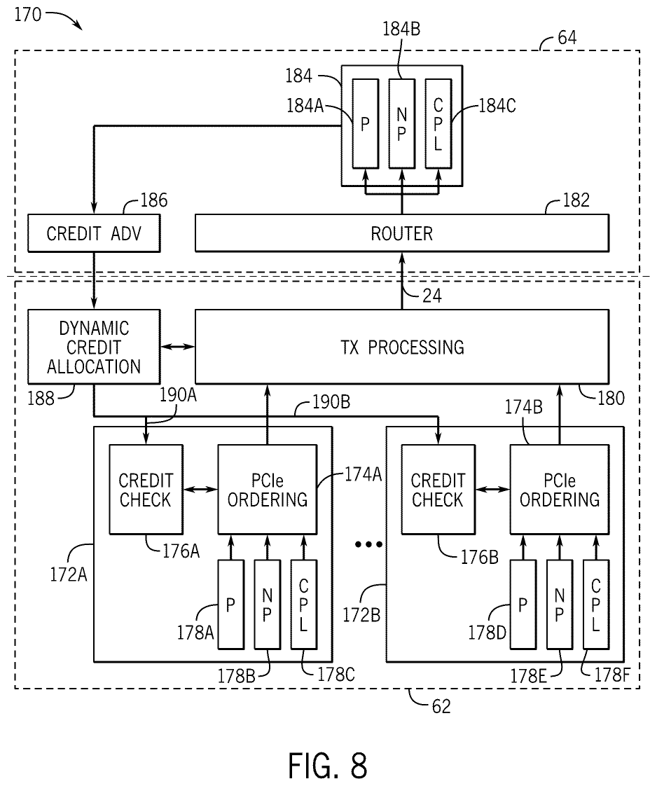

The present disclosure may also provide benefits to transmitters engaged in data communications (e.g., PCIe communications). Indeed, as mentioned with reference to FIG. 3, a communicative system may include a transmitter and a receiver that are coupled over a communication link, such as a PCIe link. The transmitter may also include an integrated circuit that may be or include a PCIe interface. The integrated circuit of the transmitter may also be configured to increase the throughput of the data communications (e.g., the PCIe communications). With this in mind, FIG. 8 is a block diagram 170 of the communicative system of FIG. 3 that includes a transmitter configured to engage in dynamic credit allocation. A transmitter 62 may communicate with a receiver 64 via a communication link 24 (e.g., a PCIe link). The transmitter 62 and the receiver 64 may be link partners. As discussed above, the transmitter 62 may also include multiple streams 172A, 172B to provide packets to the receiver 64. It should be noted that although two streams 172A, 172B are depicted in FIG. 8, any number of streams may be included in the transmitter 62.

Each stream 172A, 172B may include, ordering circuitry 174A, 174B (e.g., PCIe ordering circuitry), a credit check 176A, 176B, and buffers 178A, 178B, 178C, 178D, 178E, 178F. By way of example, the stream 172A may include the ordering circuitry 174A and the credit check 176A. As described above, the ordering circuitry 174A may be coupled to the credit check 176A. The ordering circuitry 174A may forward packets to a transmission processing circuitry 180 based on credit information from the credit check 176A and communication protocols (e.g., PCIe protocols). The stream 172A may include buffers 178A, 178B, 178C that are associated with the different types of packets (e.g., posted, non-posted, completion). For example, the stream 172A may include a first buffer 178A for posted packets, a second buffer 178B for non-posted packets, and a third buffer 178C for completion packets. The ordering circuitry 174A may forward the packets from the buffers 178A, 178B, 178C to the transmission processing circuitry 180.

The transmission processing circuitry 180 may receive the packets from the ordering circuitry 174A, 174B in the streams 172A, 172B and forward the packets over the communication link 24 to the receiver 64. Because the communication link 24 may be a single channel, the transmission processing circuitry 180 may transmit the packets received from the streams 172A, 172B to the receiver 64 sequentially (e.g., based on timestamps).

The receiver 64 may receive the packets from the transmitter 62 at a router 182. The router 182 may be used to process the received packets and forward them to virtual interfaces 184A, 184B, 184C (e.g., buffers). In some embodiments, the virtual interfaces 184A, 184B, 184C (collectively referred to as the virtual interfaces 184) may correspond to the virtual interfaces 76, 78, 80 in FIGS. 4 and 6. That is, a first virtual interface 184A may store posted packets, a second virtual interface 184B may store non-posted packets, and a third virtual interface 184C may store completion packets. Additionally, in some embodiments, the receiver 64 may also include additional components that are described with respect to FIGS. 4 and 6. For example, the receiver 64 may include a logical physical layer (e.g., the logical physical layer 72 of FIGS. 4 and 6) and arbitration and multiplexing logic (e.g., the arbitration and multiplexing logic 74 of FIGS. 4 and 6). Returning to FIG. 8, the router 182 may be used to extract information (e.g., packet types) from the packets received over the communication link 24 and provide the packets to the appropriate virtual interface 184A, 184B, 184C based on the packet type. The virtual interfaces 184 may then provide the packets to downstream components towards an application main band.

Each of the virtual interfaces 184A, 184B, 184C may have a credit allocation. That is, to avoid downstream congestion associated with the application main band, the virtual interfaces 184A, 184B, 184C may accept a set number of packets at a given time. For example, the first virtual interface 184A may have an initial credit allocation of twenty posted packets, the second virtual interface 184B may have an initial credit allocation of twenty non-posted packets, and the third virtual interface 184C may have an initial credit allocation of twenty completion packets. The virtual interfaces 184 may provide these credits to the credit advertiser 186. The credit advertiser 186 may aggregate the available credits of the virtual interfaces 184 and periodically or continuously provide updates as to an amount of available credit in the virtual interfaces 184 to a dynamic credit allocation system 188 in the transmitter 62. That is, the credit advertiser 186 of the receiver 64 may be communicatively coupled to the dynamic credit allocation system 188 of the transmitter 62.

The dynamic credit allocation system 188 may receive the credit from the credit advertiser 186 and provide the available credit to the streams 172A, 172B. For example, the credit check 176A, 176B in each of the streams 172A, 172B may receive the credit information from the dynamic credit allocation system 188. In some embodiments, the dynamic credit allocation system 188 may provide different credit data 190A, 190B (e.g., a number of available of available credits) to the streams 172A, 172B. For example, the dynamic credit allocation system 188 may provide the credit check 176A of the stream 172A with the credit data 190A. Likewise, the dynamic credit allocation system 188 may provide the credit check 176B of the stream 172B with the credit data 190B. The credit data 190A, 190B may be dynamically provisioned between the streams 172A, 172B to improve a throughput of the transmitter 62.

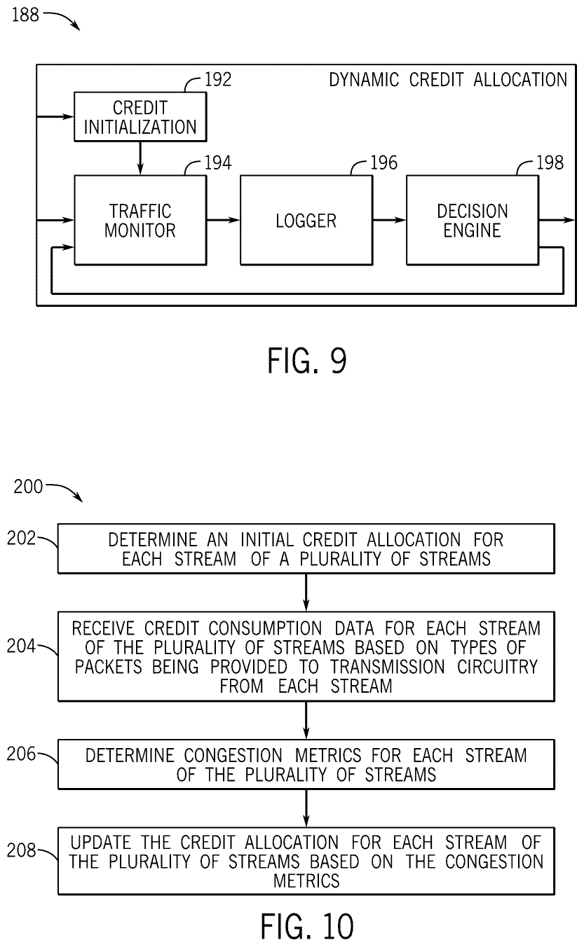

Turning to an example of the dynamic credit allocation technique described herein, FIG. 9 is a block diagram of the dynamic credit allocation system 188 of the transmitter 62 of FIG. 8. The dynamic credit allocation system may include a credit initialization system 192. The credit initialization system 192 may set a baseline amount of credit to provide (e.g., in the credit data 190A, 190B) to each of the streams 172A, 172B. The baseline amount of credit may be based on an initial amount of credit provided by the credit advertiser 186 of the receiver 64.

The dynamic credit allocation system 188 may include a traffic monitor 194 that may be coupled to the credit advertiser 186 and the credit initialization system 192. The traffic monitor 194 may track the rate at which the streams 172A, 172B deplete their credits for each type of packet. For example, the dynamic credit allocation system 188 may be coupled to the transmission processing circuitry 180. In some embodiments, the dynamic credit allocation system 188 may know how many credits are provided to each of the streams 172A, 172B based on the credit initialization system 192. Thus, the traffic monitor 194 may determine the rate at which each of the streams 172A, 172B uses its respective credits as it provides packets to the transmission processing circuitry 180.

The dynamic credit allocation system 188 may also include a logger 196. The logger 196 may record (e.g., log) congestion metrics associated with each of the streams 172A, 172B. The congestion metrics may include, for example, wait times and transmissions delays experienced by each of the streams 172A, 172B. In some embodiments, the logger 196 may record the congestion metrics based on a variance in the rate of credit consumption for each of the streams 172A, 172B (e.g., as determined by the traffic monitor 194). In some embodiments, the logger 196 may also record congestion metrics associated with periods where credits remain idle (e.g., the credits are not being used) by the streams 172A, 172B. The logger 196 may determine the periods where credits remain idle based on the rate of credit consumption determined by the traffic monitor 194. In these ways, the logger 196 may provide usage statistics for each of the streams 172A, 172B.

The dynamic credit allocation system 188 may also include a decision engine 198. The decision engine 198 may analyze the congestion metrics recorded by the logger 196 to determine how credits should be reallocated between the streams 172A, 172B. The decision engine 198 may then generate the credit data 190A, 190B that the dynamic credit allocation system 188 provides to the credit checks 176A, 176B for each of the respective streams 172A, 172B.

By way of example, the stream 172A may not use any credits for posted packets for a time (e.g., 2 seconds). The stream 172A may also use all of its non-posted credits during the time, such that it cannot transmit any more non-posted packets to the transmission processing circuitry 180. Conversely, the stream 172B may use all of its posted credits during the time, such that it cannot transmit any more posted packets to the transmission processing circuitry 180. However, the stream 172B may not use any credits for non-posted packets during the time. The traffic monitor 194 and the logger 196 may record the congestion metrics associated with this credit usage discrepancy. The decision engine 198 may determine that additional non-posted credits should be allocated to the stream 172A and additional posted credits should be allocated to the stream 172B. Thus, as the dynamic credit allocation system 188 receives updates from the credit advertiser 186 of the receiver 64, the dynamic credit allocation system 188 may steer non-posted credits towards the stream 172A and posted credits towards the stream 172B. For example, the dynamic credit allocation system 188 may provide additional non-posted credits in the credit data 190A to the stream 172A. Conversely, the dynamic credit allocation system 188 may provide additional posted credits in the credit data 190B to the stream 172B. Resultingly, although the stream 172A and 172B may have initially held a similar amount of credits for each packet type (e.g., each having ten posted credits and ten non-posted credits), based on actual credit usage, the dynamic credit allocation system 188 can dynamically adjust the credit allocation (e.g., the stream 172A receiving a credit allocation of five posted packets and fifteen non-posted packets, and the stream 172B receiving a credit allocation of fifteen posted packets and five non-posted packets) to improve throughput across the streams 172A, 172B. In this way, the transmitter 62 may reduce the risk of congestion across the multiple streams 172A, 172B and improve throughput to the receiver 64.

With this in mind, FIG. 10 is a flowchart of a method 200 for the transmitter 62 of FIG. 8 to use the dynamic credit allocation system to improve throughput to the receiver. Although the following description of the method 200 is described as being performed by the dynamic credit allocation system 188 of FIG. 10, it should be noted that any suitable device capable of receiving and processing data may perform the method 200 described herein. In addition, although the method 200 is described in a particular order, it should be understood that the method 200 may be performed in any suitable order and may exclude one or more of the blocks described herein.

At block 202, the dynamic credit allocation system may determine an initial credit allocation for each stream of multiple streams. That is, the dynamic credit allocation system may interface with a receiver that is communicatively coupled to over a communication link. For example, the dynamic credit allocation system may receive an initial credit allocation from a credit advertiser (e.g., the credit advertiser 186 of FIG. 8) of the receiver. The dynamic credit allocation system may include logic or circuitry (e.g., the credit initialization system 192 of FIG. 9) to reallocate the total number of credits that it receives form the credit advertiser to each of the streams of the transmitter. For example, if the transmitter includes eight streams, the dynamic credit allocation system may share the credits equally over each of the eight streams.

At block 204, the dynamic credit allocation system may receive credit consumption data for each stream of the multiple streams based on the types of packets being provided to transmission circuitry (e.g., the transmission processing circuitry 180 of FIG. 8) from each stream. As mentioned above, the dynamic credit allocation system may include a traffic monitor (e.g., the traffic monitor 194 of FIG. 9) to monitor the rate of credit consumption for each of the streams. The traffic monitor may determine how each stream is using its allocated credits, including determining whether any of the streams is not using its credits or is using all of its credits. In either case, if a stream has a surplus of credits or a lack of credits for a particular packet type, it may experience congestion, which may have a negative impact on the throughput of the transmitter.

At block 206, the dynamic credit allocation system may determine congestion metrics for each stream of the multiple streams. The dynamic credit allocation system may also include a logger (e.g., the logger 196 of FIG. 9) to record congestion metrics, such as transmission delays and waiting periods based on the credit consumption data provided by the traffic monitor. For example, the logger may use the credit consumption data to generate usage patterns for each of the streams.

At block 208, the dynamic credit allocation system may update the credit allocation for each stream of the multiple streams based on the congestion metrics. The dynamic credit allocation system may include a decision engine (e.g., the decision engine 198 of FIG. 9) that may determine the amount and type of credit to be provided to each stream based on the congestion metrics. As mentioned in the example above, a first stream may use more of a first type of packet than a second stream. Thus, the dynamic credit allocation system may strategically reallocate credits for the first type of packet towards the first stream. This process may be ongoing, such that the decision engine may consistently monitor the congestion metrics that are provided by the logger and, in response, dynamically allocate the available credits as they are made available (e.g., by the credit advertiser of the receiver). In this manner, the transmitter may increase throughput by reducing the likelihood of congestion across each of the multiple streams.

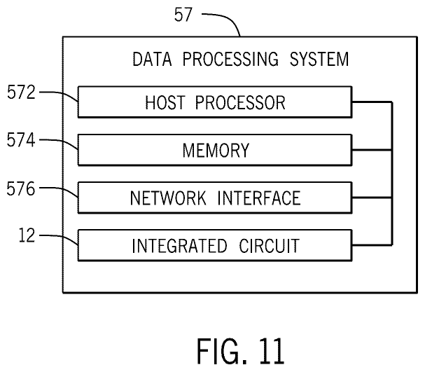

The integrated circuit device 12 discussed with respect to both the transmitter 62 and receiver 64 above may be a component included in a data processing system, such as a data processing system 500, shown in FIG. 11. The data processing system 500 may include the integrated circuit device 12 (e.g., a programmable logic device, an application specific integrated circuit (ASIC)), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIGS. 4, 6, and 8 may include the NOC 46 of the integrated circuit device 12. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams) for programming the integrated circuit device 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

### EXAMPLE EMBODIMENTS

EXAMPLE EMBODIMENT 1. An integrated circuit device comprising:
an application main band;
a plurality of streams configured to provide packets to the application main band; and
communication protocol ordering circuitry configured to route the packets to the plurality of streams.
   EXAMPLE EMBODIMENT 2. The integrated circuit of example embodiment 1, wherein the communication protocol ordering circuitry comprises Peripheral Component Interconnect Express (PCIe) ordering circuitry.
   EXAMPLE EMBODIMENT 3. The integrated circuit device of example embodiment 1, comprising:
a credit update coupled to the application main band and configured to aggregate credits for the plurality of streams; and
a credit check coupled to the credit update and the communication protocol ordering circuitry, wherein the communication protocol ordering circuitry routes packets to the plurality of streams based on credits from the credit check.
   EXAMPLE EMBODIMENT 4. The integrated circuit device of example embodiment 1, wherein each of the plurality of streams comprises a respective credit check coupled to the application main band, wherein the plurality of streams provide the packets to the application main band based on the respective credit checks.
   EXAMPLE EMBODIMENT 5. The integrated circuit device of example embodiment 4, wherein each of the plurality of streams comprises:
a priority multiplexer coupled to the credit check; and
an auxiliary buffer coupled to the priority multiplexer, wherein the auxiliary buffer is configured to receive packets based on the credit check having an insufficient amount of credit for the packets.
   EXAMPLE EMBODIMENT 6. The integrated circuit device of example embodiment 4, wherein the credit check on each of the plurality of streams is based on a type of packet, the type of packet being one of: a posted packet, a non-posted packet, or a completion packet.
   EXAMPLE EMBODIMENT 7. The integrated circuit device of example embodiment 1 comprising a Transaction Layer Packet (TLP) decoder and router coupled to the communication protocol ordering circuitry and the plurality of streams, wherein the TLP decoder and router is configured to route a set of the packets to a particular stream of the plurality of streams.
   EXAMPLE EMBODIMENT 8. The integrated circuit device of example embodiment 1, comprising an interface connection to a single channel Peripheral Component Interconnect Express (PCIe) link, wherein the integrated circuit receives the packets from the PCIe link.
   EXAMPLE EMBODIMENT 9. The integrated circuit device of example embodiment 8, comprising a plurality of virtual interfaces coupled to the communication protocol ordering circuitry, wherein each of the plurality of virtual interfaces is associated with a type of packet, and the integrated circuit is configured to buffer the packets in the virtual interfaces.
   EXAMPLE EMBODIMENT 10. The integrated circuit device of example embodiment 1, wherein the plurality of streams comprise first in, first out (FIFO) buffers.
   EXAMPLE EMBODIMENT 11. A receiver, comprising:
an interface coupled to a communication link; and
an integrated circuit coupled to the interface, the integrated circuit comprising:
   a plurality of streams coupled to an application main band, the plurality of streams being configured to provide packets to the application main band; and
   communication protocol ordering circuitry configured to route the packets to the plurality of streams.
      EXAMPLE EMBODIMENT 12. The receiver of example embodiment 11, wherein the communication link comprises a Peripheral Component Interconnect Express (PCIe) link, and the communication protocol ordering circuitry comprises PCIe ordering circuitry.
      EXAMPLE EMBODIMENT 13. The receiver of example embodiment 11, wherein the integrated circuit comprises:
a credit update coupled to the application main band and configured to aggregate credits for the plurality of streams; and
a credit check coupled to the credit update and the communication protocol ordering circuitry, wherein the communication protocol ordering circuitry routes packets to the plurality of streams based on credits from the credit check.
   EXAMPLE EMBODIMENT 14. The receiver of example embodiment 13, wherein the credits correspond to a type and quantity of packets based on an availability of the application main band to accept the packets.
   EXAMPLE EMBODIMENT 15. The receiver of example embodiment 13, wherein the communication protocol ordering circuitry is configured to pause packet routing based on the credit check.
   EXAMPLE EMBODIMENT 16. The receiver of example embodiment 14, wherein each stream of the plurality of streams comprises an additional credit check coupled to the application main band.
   EXAMPLE EMBODIMENT 17. The receiver of example embodiment 16, wherein each stream of the plurality of streams is configured to temporarily stop providing packets to the application main band based on the additional credit check.
   EXAMPLE EMBODIMENT 18. The receiver of example embodiment 11, wherein the integrated circuit comprises a plurality of virtual interfaces coupled to the communication protocol ordering circuitry, wherein the plurality of virtual interfaces are configured to buffer the packets received at the interface coupled to the communication link.
   EXAMPLE EMBODIMENT 19. A method comprising:
receiving, via an integrated circuited, a packet at a communication link;
identifying, via the integrated circuit, a category of the packet, the category being one of: a posted packet, a non-posted packet, or a completion packet;
determining, via the integrated circuit, that there is a sufficient amount of aggregate credit across a plurality of a first in, first out (FIFO) buffers to route the packet to an application;
in response to the application having the sufficient amount of aggregate credit to receive the packet, routing, via the integrated circuit, the packet to a particular FIFO buffer of the plurality of FIFO buffers;
determining, via the integrated circuit, that the application has a sufficient amount of credit to receive the packet from the particular FIFO buffer based on the category of the packet;
in response to the application having the sufficient amount of credit to receive the packet from the particular FIFO buffer, providing, via the integrated circuit, the packet to the application; and
updating, via the integrated circuit, the aggregate credit for the plurality of FIFO buffers based on the packet provided to the application.
   EXAMPLE EMBODIMENT 20. The method of example embodiment 19, comprising: in response to the application having an insufficient amount of credit to receive the packet from the particular FIFO buffer, transmitting, via the integrated circuit, the packet to an auxiliary buffer.
   EXAMPLE EMBODIMENT 21. An integrated circuit device comprising:
transmission processing circuitry configured to transmit packets over a communication link; and
a plurality of streams coupled to the transmission processing circuitry; wherein each stream of the plurality of streams comprises:
   a plurality of buffers associated with different packet types; and
   a credit check, wherein each stream is configured to provide packets to the transmission processing circuitry based on an indication provided by the credit check.
      EXAMPLE EMBODIMENT 22. The integrated circuit device of example embodiment 21, wherein each stream of the plurality of streams comprises communication protocol ordering circuitry coupled to the transmission processing circuitry and the credit check, the communication protocol ordering circuitry being configured to transmit packets from the plurality of buffers to the transmission processing circuitry.
      EXAMPLE EMBODIMENT 23. The integrated circuit device of example embodiment 22, wherein the communication link comprises a Peripheral Component Interconnect Express (PCIe) link, and the communication protocol ordering circuitry comprises PCIe ordering circuitry.
      EXAMPLE EMBODIMENT 24. The integrated circuit device of example embodiment 21, wherein the indication provided by the credit check is based on a type of packet.
      EXAMPLE EMBODIMENT 25. The integrated circuit device of example embodiment 24, comprising a dynamic credit allocation system coupled to the credit check on each of the plurality of streams, the dynamic credit allocation system being configured to provide credits to the credit check on each of the plurality of streams.
      EXAMPLE EMBODIMENT 26. The integrated circuit device of example embodiment 25, wherein the dynamic credit allocation system is configured to adjust an amount of credits provided to a particular stream of the plurality of streams based on credit consumption data for the particular stream.
      EXAMPLE EMBODIMENT 27. The integrated circuit device of example embodiment 25, wherein the dynamic credit allocation system is communicatively coupled to a receiver, the dynamic credit allocation system being configured to determine a number of credits for the plurality of streams based on credits advertised by the receiver.
      EXAMPLE EMBODIMENT 28. The integrated circuit device of example embodiment 25, wherein the dynamic credit allocation system comprises:
a traffic monitor configured to generate credit consumption data for each stream of the plurality of streams;
a logger configured to generate congestion metrics for each stream of the plurality of streams based on the credit consumption data; and
a decision engine configured to adjust an amount of credits provided to the plurality of streams based on congestion metrics.
   EXAMPLE EMBODIMENT 29. The integrated circuit device of example embodiment 28, wherein the congestion metrics comprise transmission delays and waiting periods based on a variance in a rate of credit consumption for at least two streams of the plurality of streams.
   EXAMPLE EMBODIMENT 30. A system comprising:
a receiver comprising a plurality of virtual interfaces configured to store packets;
a transmitter coupled to the receiver by a communication link, the transmitter comprising:
   transmission processing circuitry configured to transmit packets to the receiver over the communication link; and
   a plurality of streams coupled to the transmission processing circuitry; wherein each stream of the plurality of streams comprises:
      a plurality of buffers associated with different packet types; and
      a credit check, wherein each stream is configured to provide packets to the transmission processing circuitry based on an indication provided by the credit check.
         EXAMPLE EMBODIMENT 31. The system of example embodiment 30, wherein the transmitter comprises a dynamic credit allocation system coupled to each of the plurality of streams, the dynamic credit allocation system being configured to provide a number of credits to the credit check on each of the plurality of streams.
         EXAMPLE EMBODIMENT 32. The system of example embodiment 31, wherein the dynamic credit allocation system adjusts the credits provided to each of the plurality of streams based on a rate of credit consumption associated with packet types for each of the plurality of streams.
         EXAMPLE EMBODIMENT 33. The system of example embodiment 31, wherein the receiver comprises a credit advertiser based on an aggregate amount of available credit for the plurality of virtual interfaces.
         EXAMPLE EMBODIMENT 34. The system of example embodiment 33, wherein the dynamic credit allocation system is communicatively coupled to the credit advertiser and configured to adjust the credit provided to each of the plurality of streams based on an indication of the aggregate amount of available credit for the plurality of virtual interfaces from the credit advertiser.
         EXAMPLE EMBODIMENT 35. The system of example embodiment 33, wherein the dynamic credit allocation system is configured to set an initial credit allocation for each of the plurality of streams based on an indication of available credit provided by the credit advertiser.
         EXAMPLE EMBODIMENT 36. A method comprising:
determining, via a dynamic credit allocation system of a transmitter coupled to a receiver via a communication link, an initial credit allocation for each stream of a plurality of streams;
receiving, via the dynamic credit allocation system, credit consumption data for each stream of the plurality of streams based on a type of packets being provided to transmission circuitry from each stream;
determining, via the dynamic credit allocation system, congestion metrics for each stream of the plurality of streams based on the credit consumption data; and
updating, via the dynamic credit allocation system, the credit allocation for each stream of the plurality of streams based on the congestion metrics.
   EXAMPLE EMBODIMENT 37. The method of example embodiment 36, wherein the congestion metrics indicate that a stream of the plurality of streams is congested due to a lack of credits for the type of packets being provided to transmission circuitry.
   EXAMPLE EMBODIMENT 38. The method of example embodiment 36, wherein the congestion metrics indicate that a stream of the plurality of streams has a surplus of credits for the type of packets being provided to transmission circuitry.
   EXAMPLE EMBODIMENT 39. The method of example embodiment 36, wherein the dynamic credit allocation system wherein the initial credit allocation is the same for each stream of the plurality of streams.
   EXAMPLE EMBODIMENT 40. The method of example embodiment 39, wherein updating, via the dynamic credit allocation system, the credit allocation for each stream of the plurality of streams comprises allocating a greater number of credits for a particular packet type to a first stream of the plurality of streams than a second stream of the plurality of streams.

What is claimed is:

1. An integrated circuit device comprising:
an application main band;
a plurality of streams configured to provide packets to the application main band; and
communication protocol ordering circuitry configured to route the packets to the plurality of streams.

2. The integrated circuit of claim 1, wherein the communication protocol ordering circuitry comprises Peripheral Component Interconnect Express (PCIe) ordering circuitry.

3. The integrated circuit device of claim 1, comprising:
a credit update coupled to the application main band and configured to aggregate credits for the plurality of streams; and
a credit check coupled to the credit update and the communication protocol ordering circuitry, wherein the communication protocol ordering circuitry routes packets to the plurality of streams based on credits from the credit check.

4. The integrated circuit device of claim 1, wherein each of the plurality of streams comprises a respective credit check coupled to the application main band, wherein the plurality of streams provide the packets to the application main band based on the respective credit checks.

5. The integrated circuit device of claim 4, wherein each of the plurality of streams comprises:
a priority multiplexer coupled to the credit check; and
an auxiliary buffer coupled to the priority multiplexer, wherein the auxiliary buffer is configured to receive packets based on the credit check having an insufficient amount of credit for the packets.

6. The integrated circuit device of claim 4, wherein the credit check on each of the plurality of streams is based on a type of packet, the type of packet being one of: a posted packet, a non-posted packet, or a completion packet.

7. The integrated circuit device of claim 1 comprising a Transaction Layer Packet (TLP) decoder and router coupled to the communication protocol ordering circuitry and the plurality of streams, wherein the TLP decoder and router is configured to route a set of the packets to a particular stream of the plurality of streams.

8. The integrated circuit device of claim 1, comprising an interface connection to a single channel Peripheral Component Interconnect Express (PCIe) link, wherein the integrated circuit receives the packets from the PCIe link.

9. The integrated circuit device of claim 8, comprising a plurality of virtual interfaces coupled to the communication protocol ordering circuitry, wherein each of the plurality of virtual interfaces is associated with a type of packet, and the integrated circuit is configured to buffer the packets in the virtual interfaces.

10. The integrated circuit device of claim 1, wherein the plurality of streams comprise first in, first out (FIFO) buffers.

11. A receiver, comprising:
an interface coupled to a communication link; and
an integrated circuit coupled to the interface, the integrated circuit comprising:
a plurality of streams coupled to an application main band, the plurality of streams being configured to provide packets to the application main band; and
communication protocol ordering circuitry configured to route the packets to the plurality of streams.

12. The receiver of claim 11, wherein the communication link comprises a Peripheral Component Interconnect Express (PCIe) link, and the communication protocol ordering circuitry comprises PCIe ordering circuitry.

13. The receiver of claim 11, wherein the integrated circuit comprises:
a credit update coupled to the application main band and configured to aggregate credits for the plurality of streams; and
a credit check coupled to the credit update and the communication protocol ordering circuitry, wherein the communication protocol ordering circuitry routes packets to the plurality of streams based on credits from the credit check.

14. The receiver of claim 13, wherein the credits correspond to a type and quantity of packets based on an availability of the application main band to accept the packets.

15. The receiver of claim 13, wherein the communication protocol ordering circuitry is configured to pause packet routing based on the credit check.

16. The receiver of claim 14, wherein each stream of the plurality of streams comprises an additional credit check coupled to the application main band.

17. The receiver of claim 16, wherein each stream of the plurality of streams is configured to temporarily stop providing packets to the application main band based on the additional credit check.

18. The receiver of claim 11, wherein the integrated circuit comprises a plurality of virtual interfaces coupled to the communication protocol ordering circuitry, wherein the plurality of virtual interfaces are configured to buffer the packets received at the interface coupled to the communication link.

19. A method comprising:
receiving, via an integrated circuited, a packet at a communication link;
identifying, via the integrated circuit, a category of the packet, the category being one of: a posted packet, a non-posted packet, or a completion packet;
determining, via the integrated circuit, that there is a sufficient amount of aggregate credit across a plurality of a first in, first out (FIFO) buffers to route the packet to an application;
in response to the application having the sufficient amount of aggregate credit to receive the packet, routing, via the integrated circuit, the packet to a particular FIFO buffer of the plurality of FIFO buffers;
determining, via the integrated circuit, that the application has a sufficient amount of credit to receive the packet from the particular FIFO buffer based on the category of the packet;
in response to the application having the sufficient amount of credit to receive the packet from the particular FIFO buffer, providing, via the integrated circuit, the packet to the application; and
updating, via the integrated circuit, the aggregate credit for the plurality of FIFO buffers based on the packet provided to the application.

20. The method of claim 19, comprising: in response to the application having an insufficient amount of credit to receive the packet from the particular FIFO buffer, transmitting, via the integrated circuit, the packet to an auxiliary buffer.
